(19) United States
(12) Patent Application Publication
(10) Pub. No.: US 2024/0329219 A1
(43) Pub. Date: Oct. 3, 2024

(54) Extrinsic LiDAR Calibration

(71) Applicant: OPSYS Tech Ltd., Holon (IL)

(72) Inventors: Jacov Kagan, Jerusalem (IL); Yakov Weinberg, Holon (IL); Shlomo Yehezkel, Holon (IL); Niv Maayan, Gealiya (IL)

(73) Assignee: OPSYS Tech Ltd., Holon (IL)

(21) Appl. No.: 18/619,069

(22) Filed: Mar. 27, 2024

Related U.S. Application Data
(60) Provisional application No. 63/493,710, filed on Mar. 31, 2023.

(51) Int. Cl. G01S 7/497; G01S 17/89

(52) U.S. Cl. CPC G01S 7/497; G01S 17/89

(57) ABSTRACT

A method of calibrating a LiDAR system includes providing a calibration target with an IR source. A partially IR opaque mask is proximate to the source and defines a plurality of regions with known areas that are at least partially transparent to IR. A vehicle coordinate system is then determined. The calibration target is then positioned in the vehicle coordinate system in a predetermined position with a predetermined orientation. An image of the calibration target is acquired with the LIDAR sensors. Image processing is performed to determine the position and orientation of the calibration target in the LiDAR sensors coordinate system. A rotation of the LIDAR sensors around an axis of attachment of the LiDAR sensor is determined from the image processing that compensates for misalignment of the LIDAR sensors. The LIDAR sensor coordinate system is then adjusted to match the vehicle coordinate system based on the determined rotation.

### CROSS-REFERENCE TO RELATED APPLICATION

The present application is non-provisional of U.S. Provisional Patent Application No. 63/493,710 entitled “Extrinsic LiDAR Calibration”, filed on Mar. 31, 2023. The entire contents of U.S. Provisional Patent Application No. 63/493,710 are herein incorporated by reference.

The section headings used herein are for organizational purposes only and should not be construed as limiting the subject matter described in the present application in any way.

### INTRODUCTION

Autonomous, self-driving, and semi-autonomous automobiles use a combination of different sensors and technologies such as radar, image-recognition cameras, and sonar for detection and location of surrounding objects. These sensors enable a host of improvements in driver safety including collision warning, automatic-emergency braking, lane-departure warning, lane-keeping assistance, adaptive cruise control, and piloted driving. Among these sensor technologies, light detection and ranging (LiDAR) systems take a critical role, enabling real-time, high-resolution 3D mapping of the surrounding environment.

LiDAR systems need to be able to perform under a variety of environmental and driving conditions, including situations that include combinations of near and far distances of objects and various weather and ambient lighting conditions. It is important that the LiDAR be able to provide accurate object size information in these and other conditions. Collecting data from various sensors gives rise to the need for robust calibration procedures that need to be performed at both the factory during installation in the production line and also need to be periodically performed at service stations for on-going calibration and maintenance. In addition, collecting data from various sensors gives rise to the need for robust calibration procedures that need to be performed in the field during normal use of the vehicle on an ongoing basis.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale; emphasis instead generally being placed upon illustrating principles of the teaching. The drawings are not intended to limit the scope of the Applicant's teaching in any way.

FIG. 1 illustrates a schematic diagram of an extrinsic calibration process for calculating the actual sensor-to-vehicle coordination transformation according to the present teaching.

FIG. 2 illustrates a schematic diagram of extrinsic calibration target setup according to the present teaching.

FIG. 3 illustrates a flow chart of a method according to the present teaching for unifying a vehicle coordinate system to a sensor coordinate system to calibrate a LiDAR system.

FIG. 4A illustrates a region of interest that includes a target used in extrinsic calibration methods according to the present teaching.

FIG. 4B illustrates a method of extrinsic calibration according to the present teaching.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

LiDAR systems for autonomous cars must be able to perform under a variety of driving scenarios. For example, accurate range and image data that can be in the form of a three-dimensional point cloud must be obtained for a reflective traffic cone a few meters away, as well as for a vehicle tire lying in the roadway, say one hundred fifty meters away. From an optical perspective, these two scenarios present substantially different characteristics. Calibration method must be used that calibrate the system for use in a wide variety of driving conditions and driving scenarios

Commonly, the various sensors used in LiDAR systems have quite different characteristics. This characteristic diversity produces a wide range of problems that needs to be addressed. Collecting data from various sensors gives rise to the need for robust calibration procedures that need to be performed at the factory during manufacturing, at service stations for maintenance and periodic calibration, and in normal driving conditions. It is desirable to have at least some calibration during routine startup conditions. An adaptive LiDAR system is needed that can advantageously provide improved image and object identification properties as conditions change and evolve.

Some of the many challenges in calibrating and maintaining calibration of LiDAR systems relate to cost limitations of LiDAR systems installed in consumer vehicles. These limitations result in sensors that have intrinsically low sensor resolution, low dynamic range of data produced by the sensor, large systematic errors in sensor build, large tolerances in the sensor specification, and limitation on computational resource consumption of the procedure. Other challenges in calibrating and maintaining calibration of LiDAR systems relate to the environment and calibration scenario, such as practical time limitations for the calibration procedure, size limitations on the auxiliary setup used for the calibration procedure, accuracy of the auxiliary setup used in the calibration procedure, and the need for an adaptive calibration procedure in an uncontrolled environment, such as during normal driving condition. Improved extrinsic calibration processes are needed to calibrate and maintain calibration of state-of-the-art LiDAR systems.

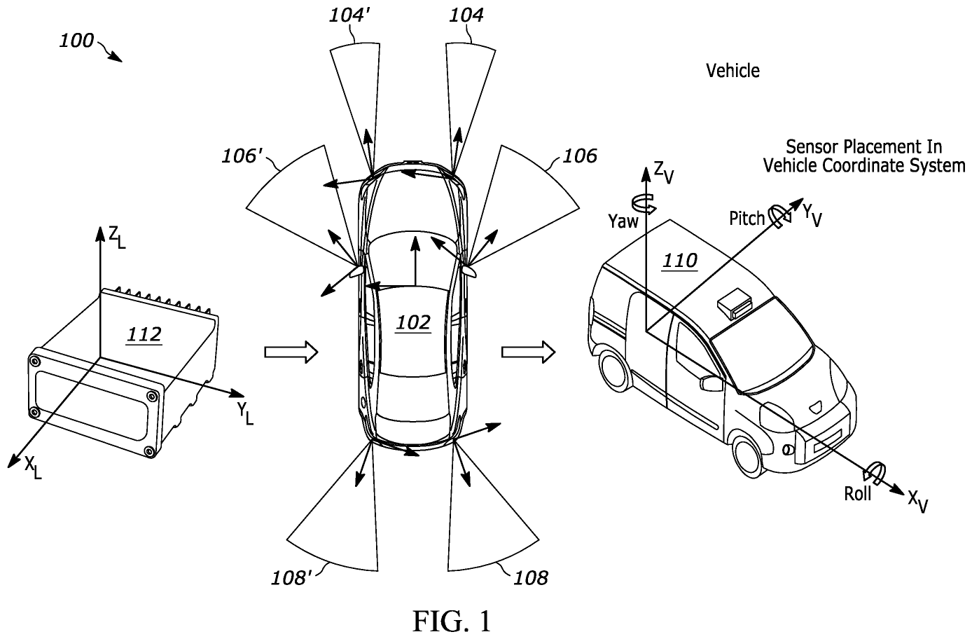

FIG. 1 illustrates a schematic diagram of an extrinsic calibration process 100 for calculating the actual sensor-to-vehicle coordination transformation according to the present teaching. The diagram 100 illustrates a drawing of a vehicle 102 with three sensor fields-of-view 104, 104′, 106, 106′, 108, 108′. The diagram of the extrinsic calibration process 100 also shows a perspective view of a vehicle 110 along with the sensor placement in the vehicle coordinate system (X_{V}, Y_{V}, Z_{V}). In addition, the diagram of the extrinsic calibration process 100 shows a LiDAR sensor 112 in the LiDAR sensor coordinate system (X_{L}, Y_{L}, Z_{L}).

The extrinsic calibration process 100 can be a joint process that is performed by the LiDAR system manufacturer and the vehicle manufacture. For example, the vehicle coordinate system, sensor locations, and pointing angle in the vehicle coordinate system are typically defined by the vehicle manufacturer. The target placement and any method limitations can also be specified by the vehicle manufacturer.

The LiDAR manufacture typically calculates the theoretical rotation matrices for installation and configures the calibration tool with relevant geometrical configuration. Then, the vehicle manufacturer would typically perform the sensor installation according to the LiDAR manufacturers geometrical definition. Finally, the vehicle manufacturer would perform final calibration to compensate for installation tolerances.

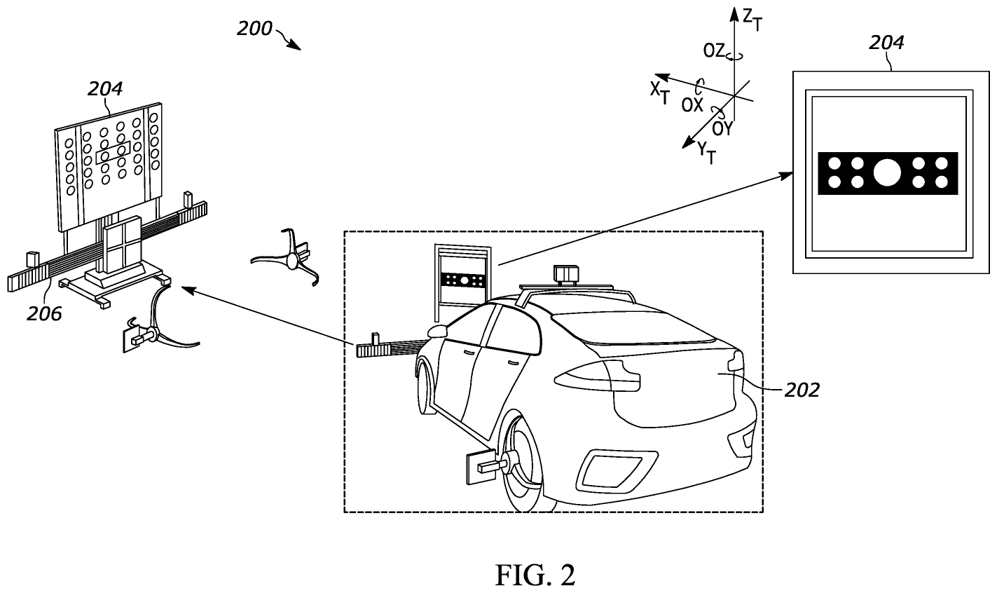

FIG. 2 illustrates a schematic diagram of extrinsic calibration target setup 200 according to the present teaching. The schematic diagram shows a vehicle 202 behind a target 204 comprising a plurality of disks. The schematic diagram also shows an expanded view of the target 204. In one specific method according to the present teaching, the distance between the sensor and the target 204 is about 2.5 meters. Also, in one specific method according to the present teaching, the compound sensor vehicle assembly tolerance in the Z and X direction is ±2° and in the Y direction is ±1°. Calibration times can be on order of 30 seconds. However, it should be understood that these numbers are not limiting the present teaching.

In addition, the schematic diagram shows a detailed view of the target 204 being supported by a frame 206. This extrinsic calibration target setup 200 is typical of what would be used to practice the methods of the present teaching during production in an assembly line during the manufacturing of the vehicle 202 and/or in a service station that is performing maintenance on the LiDAR system.

A calibration target for calibrating a LIDAR system according to the present teaching includes an infrared light source having an emitting surface that emits infrared radiation. For example, the infrared light source can have an emission wavelength of 905 nm.

A mask is positioned proximate to the emitting surface of the infrared light source. The mask material can be positioned directly on the emitting surface of infrared light source. The mask can be formed of a material that is at least partially opaque to infrared radiation in some regions. For example, the mask material can be chosen to attenuate infrared radiation in the infrared spectrum by at least 10 dB or can be at least ten times more transmissive than the material forming the partially opaque material. The mask defines a plurality of regions with known areas and/or known shapes that are at least partially transparent to infrared radiation.

At least some of the plurality of regions that are at least partially transparent to infrared radiation are circular. At least two of the circular regions can have the same diameter. At least some of the plurality of regions that are at least partially transparent to infrared radiation can have a same area. At least some of the plurality of regions that are at least partially transparent to infrared radiation can have different areas. At least some of the plurality of regions that are at least partially transparent to infrared radiation can be open regions. At least some of the plurality of regions that are at least partially transparent to infrared radiation are formed of a material that it at least ten times more transmissive than the material forming the partially opaque material.

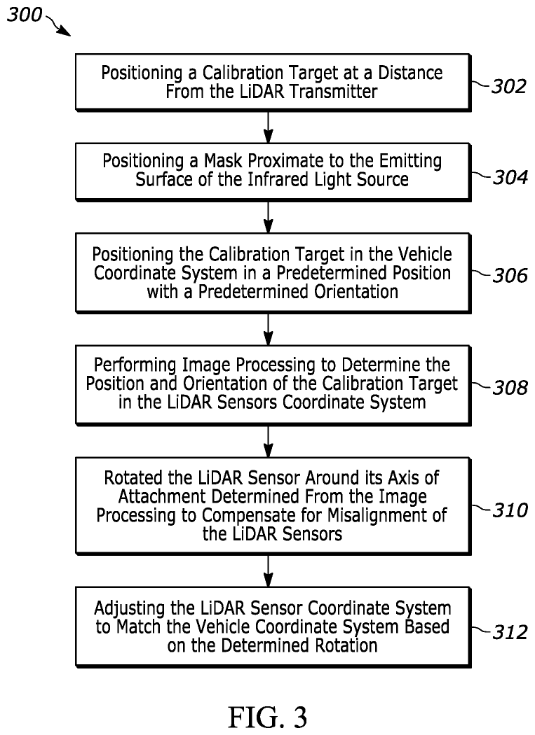

One aspect of the present teaching is that it has been discovered that quantitative data acquisition in a unified coordinate system is highly desirable for calibration of LiDAR systems. A unified coordinate system can be constructed by transforming a LiDAR sensor coordinate system to a vehicle coordinate system to assist in the calibration of the LiDAR. FIG. 3 illustrates a flow chart 300 of a method according to the present teaching for unifying a vehicle coordinate system to a sensor coordinate system to calibrate a LiDAR system.

In a first step 302, a calibration target (see, for example, calibration target 204 of FIG. 2) with an infrared light source having an emitting surface that emits infrared radiation is provided. In some methods, the calibration target 204 is positioned at a distance that is less than 100 cm from the LIDAR transmitter. In some methods, the calibration target 204 is leveled in at least one of the horizontal direction and the vertical direction. In a second step 304, a mask is positioned proximate to the emitting surface of the infrared light source. The mask is formed of a material that is at least partially opaque to infrared radiation in some regions and formed so as to define a plurality of regions with known areas and/or known shapes that are at least partially transparent to infrared radiation.

In a third step 306, the calibration target 204 (e.g., calibration target 204 of FIG. 2) is positioned in the vehicle coordinate system in a predetermined position with a predetermined orientation. An image of the calibration target is acquired with the LIDAR sensors. Some methods image the target at a frame rate of the LIDAR sensors, which is often greater than 10 frames a second and can be greater than 100 frames a second.

In a fourth step 308, image processing is performed to determine the position and orientation of the calibration target in the LiDAR sensors coordinate system. Many types of image processing can be performed to enhance the image. The image processing can include curve fitting. For example, the image processing can include curve fitting to a plurality of high resolution ellipses. As another example, the image processing can include curve fitting edges of at least some of the plurality of apertures to high resolution ellipses.

In addition, the image processing can include locating the image in a view finder and storing. Also, the image processing can include averaging the image. For example, the image can be averaged over 15 or more images. In addition, the image processing can include associating particular ones of the plurality of regions that are at least partially transparent to infrared radiation to expected images. Furthermore, the image processing can include identifying edges of particular ones of the plurality of regions that are at least partially transparent to infrared radiation and comparing to expected images. Furthermore, the image processing can include projecting at least a portion of the ellipses to at least two three-dimensional disks associating at least some of the plurality of high-resolution ellipses to three-dimensional disks and then fitting a plane through centers of at least some of the three-dimensional disks to determine pairs of disks that best match the target image.

In a fifth step 310, the LiDAR sensor is rotated around its axis of attachment determined from the image processing to compensate for misalignment of the LiDAR sensors. In a sixth step, the LiDAR sensor coordinate system is adjusted to match the vehicle coordinate system based on the determined rotation. Some methods rotate a point cloud determined by the LiDAR system based on the determined rotation around the center of the LIDAR sensor. Also, in some methods, a ridged transformation is then calculated to assess the distance of the calibration target from the LIDAR sensor.

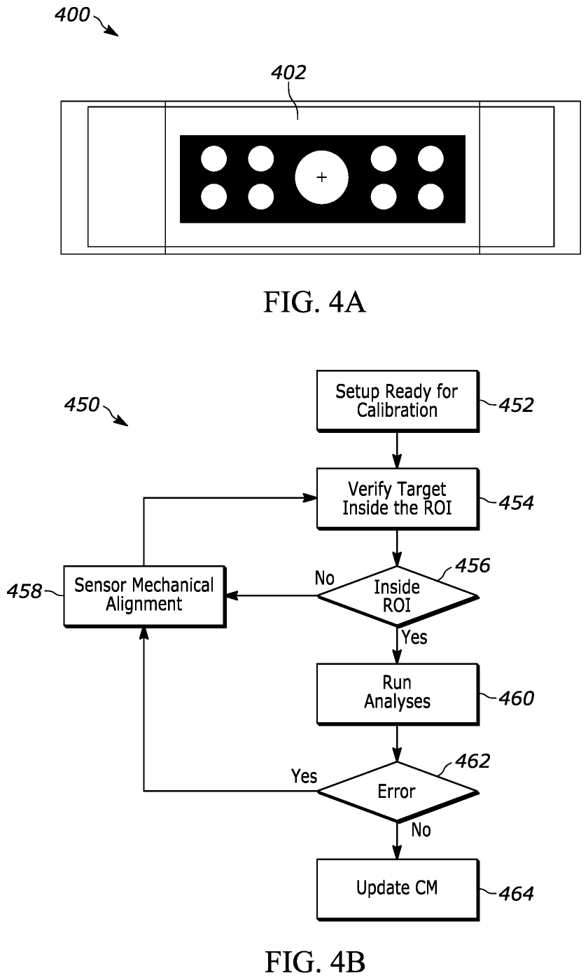

FIG. 4A illustrates a region of interest 400 that includes a target 402 used in extrinsic calibration methods according to the present teaching. The region of interest 400 includes a plurality of disks 402. Some of the plurality of disks can have different diameter. It should be understood that shapes other than circular disks can be used.

FIG. 4B illustrates a method 450 of extrinsic calibration according to the present teaching. In a first step 452, the calibration apparatus is made ready for calibration. In a second step 454, the apparatus verifies that the target 402 is inside the region of interest 400. In a third step 456, the method determines if the target 402 is or is not inside the region of interest 400.

If the target 402 is not inside the region of interest 400, a fourth step 458 is performed that mechanically aligns the sensors. Then, the second step 454 is performed again to verify that the target 402 is inside the region of interest 400. Once the method 450 verifies that the target 402 is inside the region of interest 400, a fifth step 460 performs the calibration analysis as described herein.

After the calibration analysis is performed in the fifth step 460, a sixth step 462 performs an error analysis. If the error analysis in the sixth step 462 determines that errors are above a predetermined threshold, the method returns to the fourth step 458 that performs additional mechanically alignment of the sensor. The method 450 then repeats until the method 450 determines that errors are below a predetermined threshold. When the errors are below the predetermine threshold, the updated calibration is stored in the apparatus in the seventh and final step 464.

The calibration analysis procedure varies depending on the particularities of the environment and calibration scenario addressed. In various embodiments, the analysis is based on full or partial estimation of the pose of a perspective camera. An analytic non-iterative solution can be provided. For example, methods according to the present teaching include the estimation of a given a set of known three-dimensional quadrics in the world from their corresponding 2D projections on the sensor (conics on image). In the field calibration scenario, the method includes estimation of the discrepancy between conics as perceived by different sensors, for example, the LiDAR being calibrated and the Advanced Driver Assistance Systems (ADAS) camera that presents an overlapping field-of-view.

Quantitative data acquisition according the present teaching address two problems. The first is pose estimation of a perspective camera. The second is the problem of finding optimal rotation of a perspective camera situated at a given location. One aspect of the present teaching is hardware setup and methods that addresses these and other problems with methods of transforming a LiDAR sensor coordinate system to a vehicle coordinate system for calibration of a LiDAR systems.

In one method according to the present teaching, a constellation of known geometry of quadrics, which is referred to herein is the “target”, is positioned at a predefined location and orientation in the vehicle coordinate system. The target described herein is typically a static scene target. The sensor being calibrated acquires an image of the presented target. In calibration scenarios and environmental conditions where enhancement of the image is desirable, multiple images of the target are taken and processed to mitigate the lack of sensor dynamic range and reducing image noise. For example, in some methods, the multiple images are averaged to mitigate the lack of sensor dynamic range and reducing image noise.

For each quadric of the target, the image is analyzed and then a relevant region of interest is found and the corresponding ellipse is extracted. This can be accomplished using numerous methods known in the art applied to each region of interest. For example, an edge detection algorithm can be applied and then fitted to an ellipse. See, for example, Halir, “Numerically Stable Direct Least Squares Fitting of Ellipses”, Proc. 6th International Conference in Central Europe on Computer Graphics and Visualization, WSCG, 125-132 (1998).

The covariance matrix of intensities is then calculated and an ellipse is constructed using moments of the distribution up to the 2^{nd} moments. In methods where the target is a disk, each ellipse in the image is re-projected separately from the sensor plane to three-dimensional pre-image disks. The re-projection results in two possible solutions for each ellipse. The method then selects the best candidate from each solution pair to reconstruct the given target.

In some methods, an optimization procedure is then applied to estimate the relative camera-target pose in space. Once the camera pose has been estimated, we find a best rotation for a constrained problem when no translation is allowed. This solves the problem of finding optimal rotation of a perspective camera situated at a given location.

The methods of the present teaching typically achieve an angular resolution that is an order of magnitude better than the sensor pixel resolution. Consequently, the methods of the present teaching are especially suitable for use in calibrating low resolution sensors. One feature of the methods of the present teaching is that speed is essentially limited only by the speed of image acquisition. If no multiple images are required, it can be executed in fractions of a second.

For example, if a relatively low dynamic range sensor is used, such as a moderate 14 fps frame rate, the method can be executed in roughly three seconds. Such a frame rate is acceptable for state-of-the-art automotive production lines. Furthermore, calibration targets according to the present teaching can be on order of about 50 cm in the largest dimension and can be positioned approximately one meter away from the LiDAR sensor under calibration. In one embodiment, the target is shaped in the form of a disk. Disk shaped targets are well suited for field calibration of LiDAR systems according to the present teaching.

A typical use case scenario for a LiDAR system is a circular sign, similar to a standard octagonal traffic stop sign. A disk-shaped target is a good approximation of a stop sign. In practice, using disks greatly reduces the number of required quadrics in the method. During calibration, the disk-shaped target is caught in the camera field-of-view and the LiDAR field-of-view. Triangulation of the sign (represented by the disk-shaped target) is then performed. The direction where the LiDAR is pointing vs. its nominal position is then calculated according to the present teaching using known algorithms. The result is a health alert status. In one embodiment, a health alert is triggered when a discrepancy is found above a predefined threshold. In addition to calibrating LiDAR systems, the methods of the present teaching can be used for general metrological purposes and simultaneous localization and mapping (SLAM) applications.

Another aspect of the methods of the present teaching is that prior knowledge of the sensor intrinsic parameters are assumed and used in the algorithms to reduce computational resources. The assumed sensor intrinsic parameters allow for a further reduction of the number of required quadrics essentially using two target disks. Partial calibration can be done with a single disk targets. Using a single disk for calibration is particularly useful for calibrating low resolution sensors, and sensors with relatively limited fields-of-view. Also, using a single disk for calibration is useful for adaptive field calibration in uncontrolled environment, such as when the vehicle is on the street and there is a little chance of having multiple disks in the field-of-view. This application is particularly important because it is highly desirable to perform frequent field calibration.

The methods of the present teaching have significant advantages over known methods. See, for example, Zhang, “A Flexible New Technique for Camera Calibration”, IEEE Transactions on Pattern Analysis and Machine Intelligence, 1330-1334. 2000. One advantage of the methods of the present teaching that use quandrics is that they do not require images from multiple angles. This is an important practical feature in that it greatly simplifies field calibration allowing more opportunities to calibrate as well as reducing calibration times. Furthermore, methods according to the present teaching that use quadrics have reduced the sensitivity to orientation as well as to the presence of a sensor grid. This feature is especially important for sensors that have relatively low resolution. The use of quadratics in the method also provides much higher precision in estimations.

Also, unlike some prior art methods, multiple disks can be used with a single camera to solve the pose estimation problem with no iterations. This is not possible with known methods. See, for example, Soheilian, “Multi-View 3d Circular Target Reconstruction with Uncertainty Analysis”, ISPRS Annals of the Photogrammetry, Remote Sensing and Spatial Information Sciences, 2014. This feature also simplifies the calibration process in all situations.

Furthermore, having a particularly simple form of target, the methods of the present teaching can efficiently solve the pose estimation problem with only two disks unlike known methods that use a relatively large number of quadrics, such as the twelve-disk target described in Gaudillière, “Perspective-12-Quadric: An Analytical Solution to the Camera Pose Estimation Problem From Conic-Quadric Correspondences”, 2019.

### EQUIVALENTS

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. A calibration target for calibrating a LIDAR system, the target comprising:
a) an infrared light source having an emitting surface that emits infrared radiation; and
b) a mask positioned proximate to the emitting surface of the infrared light source, the mask being formed of a material that is at least partially opaque to infrared radiation in some regions and defining a plurality of regions with known areas or known shapes that are at least partially transparent to infrared radiation.

2. The calibration target of claim 1 wherein the infrared light source is configured to emit at 940 nm.

3. The calibration target of claim 1 wherein the infrared light source is configured to emit at 905 nm.

4. The calibration target of claim 1 wherein the material is positioned directly on the emitting surface of infrared light source.

5. The calibration target of claim 1 wherein the material that is at least partially opaque to infrared radiation attenuates infrared radiation in the infrared spectrum by at least 10 dB.

6. The calibration target of claim 1 wherein at least some of the plurality of regions that are at least partially transparent to infrared radiation are circular.

7. The calibration target of claim 6 wherein at least two of the circular regions have a same diameter.

8. The calibration target of claim 1 wherein at least some of the plurality of regions that are at least partially transparent to infrared radiation have a same area.

9. The calibration target of claim 1 wherein at least some of the plurality of regions that are at least partially transparent to infrared radiation have a different area.

10. The calibration target of claim 1 wherein at least some of the plurality of regions that are at least partially transparent to infrared radiation are open regions.

11. The calibration target of claim 1 wherein at least some of the plurality of regions that are at least partially transparent to infrared radiation are formed of a material that is at least ten times more transmissive than the material forming the partially opaque material.

12. A method of transforming a LIDAR sensor coordinate system to a vehicle coordinate system for calibration of a LIDAR system, the method comprising:
a) providing a calibration target comprising an infrared light source having an emitting surface that emits infrared radiation and a mask positioned proximate to the emitting surface of the infrared light source, wherein the mask is formed of a material that is at least partially opaque to infrared radiation in some regions and defining a plurality of regions with known areas or known shapes that are at least partially transparent to infrared radiation;
b) determining a vehicle coordinate system;
c) positioning the calibration target in the vehicle coordinate system in a predetermined position with a predetermined orientation;
d) acquiring an image of the calibration target with a LIDAR sensor;
e) performing image processing to determine a position and orientation of the calibration target in a coordinate system of the LIDAR sensor;
f) determining a rotation of the LIDAR sensor around an axis of attachment of the LIDAR sensor that compensates for misalignment of the LIDAR sensor from the image processing; and
g) adjusting the coordinate system of LIDAR sensor to match the vehicle coordinate system based on the determined rotation.

13. The method of claim 12 further comprising leveling the calibration target in a horizontal direction.

14. The method of claim 12 further comprising leveling the calibration target in a vertical direction.

15. The method of claim 12 wherein the image processing is performed to enhance the image.

16. The method of claim 12 wherein the image processing comprises curve fitting.

17. The method of claim 12 wherein the image processing comprises locating the image in a view finder and storing.

18. The method of claim 12 wherein the image processing further comprises averaging the image.

19. The method of claim 18 wherein the image is averaged over 15 or more images.

20. The method of claim 12 wherein the target is imaged at a frame rate of the LIDAR sensor that is greater than 10 frames a second.

21. The method of claim 12 wherein the target is imaged at a frame rate of the LIDAR sensor that is greater than 100 frames a second.

22. The method of claim 12 wherein the image processing comprises associating particular ones of the plurality of regions that are at least partially transparent to infrared radiation to expected images.

23. The method of claim 12 wherein the image processing comprises identifying edges of particular ones of the plurality of regions that are at least partially transparent to infrared radiation and comparing to expected images.

24. The method of claim 12 further comprising rotating a point cloud determined by the LIDAR system based on the determined rotation around the center of the LIDAR sensor.

25. The method of claim 12 wherein the image processing comprises fitting images to a plurality of high-resolution ellipses.

26. The method of claim 25 wherein the image processing further comprises projecting at least a portion of the ellipses to at least two three-dimensional disks associating at least some of the plurality of high resolution ellipses to three-dimensional disks and then fitting a plane through centers of at least some of the three-dimensional disks to determine pairs of disks that best match the target image.

27. The method of claim 12 wherein the image processing comprises fitting edges of at least some of the plurality of apertures to high resolution ellipses.

28. The method of claim 12 wherein the positioning the calibration target comprises positioning the calibration target at a distance that is less than 100 cm from the LIDAR transmitter.

29. The method of claim 12 further comprising calculating a ridged transformation to assess a distance of the calibration target from the LIDAR sensor.
